(19) United States
(12) Patent Application Publication
(10) Pub. No.: US 2006/0104782 A1
(43) Pub. Date: May 18, 2006

(54) Apparatus for collecting waste

(75) Inventors: Sieger Dijkstra, Groningen (NL); Klaas de Vries, Groningen (NL)

Correspondence Address: BIRCH STEWART KOLASCH & BIRCH, PO BOX 747, FALLS CHURCH, VA, 22040-0747, US

(73) Assignee: Dijkstra Holding B.V., Groningen (NL)

(21) Appl. No.: 10/542,021

(22) PCT Filed: Jan. 9, 2004
(86) PCT No.: PCT/NL04/00016

§ 371 Date: Sep. 8, 2005

(30) Foreign Application Priority Data
Jan. 10, 2003 (NL) 1022354

(51) Int. Cl. B65F 9/00

(52) U.S. Cl. 414/659

(57) ABSTRACT

An apparatus for collecting refuse, comprising—a refuse bin (6) with an inlet opening (25) and a outlet (23) opening; a housing (3) preferably situated at least laregely underground; a reservoir (4) which in a first position is received substantially within the housing (3) and is in open communication with the outlet opening (23) of the refuse bin (6); and—lifting means (5) which are received at least partly in the housing (3) and are arranged for moving the reservoir (4) between the first position and a second position, in which the reservoir (4) is situated above ground, such that it can be emptied or replaced with an empty reservoir.

The invention relates to an apparatus for collecting waste and refuse.

It is known to provide the public space with litter bins for collecting waste, such as food leftovers and packaging material. These litter bins are typically relatively small, which provides the advantage that they can easily be placed at virtually at location, and do not appreciably stand out in the visual impression of the street. However, a disadvantage of these known small litter bins is that they fill up rapidly and therefore have to be emptied regularly. This is done manually by opening the bin and emptying an inner box or bin liner fitted therein into a passing collection vehicle. This is labour intensive and unpleasant work and moreover causes nuisance in the form of noise, smell and temporary disturbance of traffic.

Further known are dustbins of a larger storage capacity, such as bottle banks and neighbourhood containers, which can be disposed at least partly underground so as not to affect the visual impression of the street. These bins are emptied by discharging the bin with the aid of a tackle installation above a refuse collection facility via a releasable opening in the bottom of the bin. An advantage of these dustbins is that by virtue of their large storage capacity they need to be emptied infrequently, so that manpower and material can be saved and, moreover, that emptying can largely be done mechanical and therefore requires little effort. However, a drawback is that because of the tackle installation, the receptacle bins are only applicable at properly accessible locations. Moreover, coupling on, hoisting, re-placing and uncoupling the bin is time consuming, so that nuisance (smelt noise, traffic disturbance) accompanying the emptying continues for a relatively long time.

The invention contemplates an apparatus for collecting rubbish and waste, which obviates drawbacks of the known apparatuses while maintaining the advantages thereof. To that end, an apparatus according to the invention is characterized by the features of claim 1.

By virtue of these features, an apparatus is obtained having a relatively large storage capacity, which needs to be emptied with low frequency and which moreover, by virtue of the lifting means, can be emptied simply and rapidly. This does not require any bulky tackle installation, so that the refuse apparatus is suitable for use at locations that are not or difficultly accessible to the known tackle installations, such as narrow streets, alley, pedestrian areas or areas with many differences in level. Furthermore, the apparatus does not need to be coupled and uncoupled and manoeuvred back to a position of use. As a result, emptying can be done more quickly, no specific operating skill is required and nuisance cam be limited to a minimum.

In an advantageous embodiment, an apparatus according to the invention is characterized by the features of claim 2.

By connecting the reservoir to the lifting means in a pivotable manner, a refuse collection facility does not need to be manoeuvred to a point under the reservoir, but this reservoir, optionally guided by suitable guiding means and damping means, can be accurately and rapidly pivoted to a predetermined location in one continuous movement, to be emptied above a refuse collection facility set up at that location. Preferably, the pivoting direction is oriented such that the pivoting of the full reservoir from the position of use to the discharge location occurs under the influence of gravity. Thus, in an advantageous manner, use is made of potential energy. Pivoting the reservoir back into the position of use, against gravity, does require external energy, but it will be low since at that time the reservoir is empty and hence relatively light. Instead of the reservoir, or in addition thereto, the lifting means themselves may also be designed to be pivotable.

In a further advantageous elaboration, an apparatus according to the invention is characterized by the features of claim 4 or claim 9.

The lifting means can be driven manually, for instance by a crank mechanism, or mechanically, for instance pneumatically, hydraulically or electrically, or by a combination of the two. Manual driving means are typically constructionally simple, robust and hence inexpensive in purchase and maintenance. Moreover, the driving means are often noiseless in operation. Manual operation is especially suitable for medium size apparatuses, where the weight of a full reservoir is approximately it the order of magnitude of the weight of an adult. If desired, compensating means can be provided to substantially compensate the weight of the reservoir in filled condition, so that the force required for displacement is limited. Such compensating means can for instance comprise one or more biasing springs or counterweights.

With larger and hence heavier reservoirs, in addition to or instead of the manual driving means, preferably mechanical driving means are deployed. These can be arranged within the apparatus, but are preferably designed as an external unit adapted to be uncoupled, so that they can be removed after use. Thus, with a single unit, several apparatuses can be operated and the costs can be divided over several apparatuses. Moreover, as a result, when not in use, the driving means can be stored in a safe, protected place.

In the first, retracted position, the non-detachable parts of the lifting means are preferably situated underground. As a result, the lifting means sit protected from external harmful influences and cannot cause damage to the surroundings.

In a further elaboration, an apparatus according to the invention is characterized by the features of claim 10 or claim 11.

As the refuse bin moves along with the reservoir, the refuse bin does not, prior to emptying, need to be moved from the path of movement of the reservoir, and an outlet opening of the refuse bin does not need to be closed of, which contributes to the ease of use and the simplicity of the apparatus. Conversely, an apparatus in which the refuse bin does not move along with the reservoir offers the advantage that the weight to be lifted is lower.

In a particularly advantageous embodiment, an apparatus according to the invention is characterized by the features of claim 12.

An embodiment in which the housing and the reservoir are designed as two tubes fitting one into the other offers the advantage that such tubes are relatively simple to manufacture, are compact in construction and are simple to fit into the ground, with the aid of known drilling techniques. In such an embodiment, the lifting means can be designed as a toothed rack extending between the two tubes and attached to one of the tubes, preferably the inner tube, and a drivable gear wheel engaging therein. Such a lifting construction is very compact and simple in construction. Naturally, other lifting constructions are possible, in which, for instance, as already indicated hereinabove, use is made of one or more counterweights, spring means or the like that can be biased, for compensating the weight of the filled reservoir, or pneumatic or hydraulic lifting means.

It is noted that in this description, the term “tube” and “tubular” is understood to mean a relatively long, substantially hollow body, having a substantially constant cross section, which is preferably circular. A round tube can be simply drilled into the ground. However, other cross-sectional shapes are expressly understood to fall within the concept of the invention, for instance square or polygonal, in which case the tubes can be installed, for instance, by driving or burying them in the ground.

In a particularly advantageous embodiment, an apparatus according to the invention is characterized by the features of claim 15.

By placing the first tube at an angle in the ground, the stability of the apparatus is increased. Moreover, as a result, the second tube, the reservoir, can simply, under the influence of gravity, pivot to a vertical position in which the reservoir can be emptied above a refuse collection facility. The angle together with the distance over which the reservoir is lifted out of the first tube is then of influence on the location of the outlet opening of the reservoir. It is to be sufficiently high above the ground level and at a sufficient distance from the apparatus, so that a standard refuse collection facility, such as a dustcart, lorry or wheeled container, can be arranged under it.

By selecting the inclination to be great (small angle between the centreline of the tube and the ground level), the horizontal deflection of the reservoir upon pivotal movement will be relatively great, so that the refuse collection facility does not need to be arranged immediately next to the apparatus, but the second tube will have to be lifted over a relatively great distance out of the first tube in order to bring the underside of the reservoir to a sufficient height above the ground level. This requires relatively much space viewed in top plan view. Conversely, by placing the first tube approximately vertical, the second tube (the reservoir) can be brought to a sufficient height relatively simply, but the lateral deflection will be smaller, as a result of which little space is available for a refuse collection facility. Thus, in each situation, depending on the available space, an optimum angle can be selected. The values mentioned in this description are therefore not to be construed as being limitative.

In a further advantageous embodiment, an apparatus according to the invention is characterized by the features of claim 18.

What can be achieved by providing the flap of the reservoir with closing means whose movement is coupled to the movement of the reservoir, is that the flap is automatically opened when the reservoir is located above a discharge location and closed when the reservoir is received within the apparatus. Thus, the operation of the apparatus is simplified still further, and no contents can be removed from the apparatus at any undesired time.

In a particularly advantageous embodiment, the apparatus is provided with a sensor and communicating means, so that it can be monitored and communicated when the reservoir is full, so that it can always be emptied timely. Moreover, with the obtained information, a refuse collection service can plan an optimum route along the different apparatuses.

The invention further relates to a method for installing an apparatus according to the invention, wherein a tubular housing is transformed into a drill by providing it with a cutting edge, and thereupon introduced into the ground with the aid of a known drilling device. Thus, in a simple manner, without digging operations being required, an apparatus according to the invention can be installed.

In the further subclaims, further advantageous embodiments of an apparatus and method according to the invention are described.

In clarification of the invention, exemplary embodiments of a refuse apparatus according to the invention and a method for installing it will be further elucidated with reference to the drawing. In the drawing:

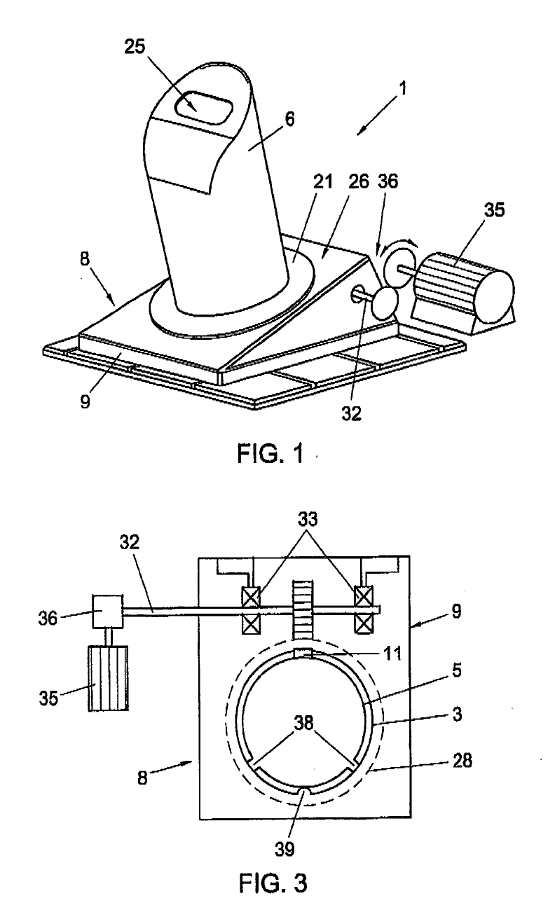

FIG. 1 shows in perspective view a first embodiment of a refuse apparatus according to the invention, in a normal position of use;

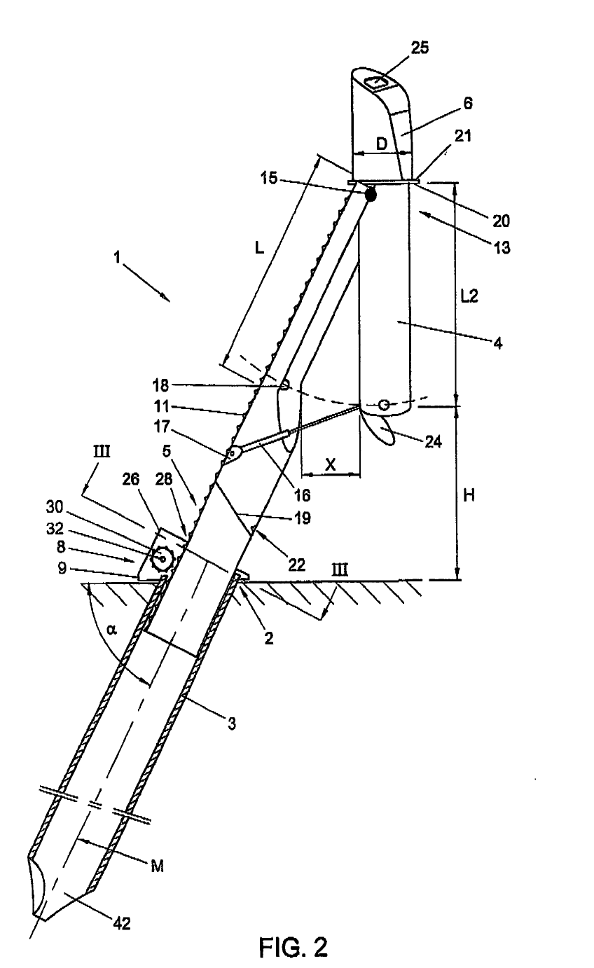

FIG. 2 shows, in partly cross-sectioned side view, the apparatus according to FIG. 1 in a position in which it can be emptied;

FIG. 3 shows the apparatus according to FIG. 1, cross-sectioned along the line III-III in FIG. 2;

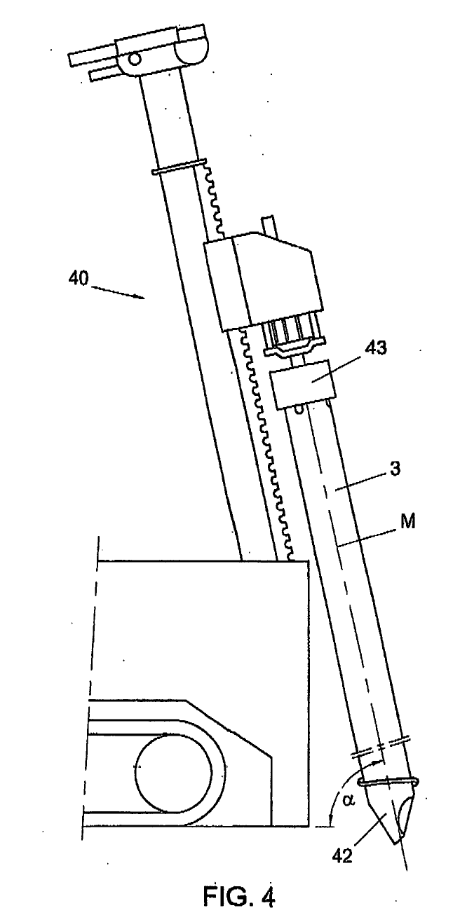

FIG. 4 shows a drilling device for installing the refuse apparatus of FIG. 1;

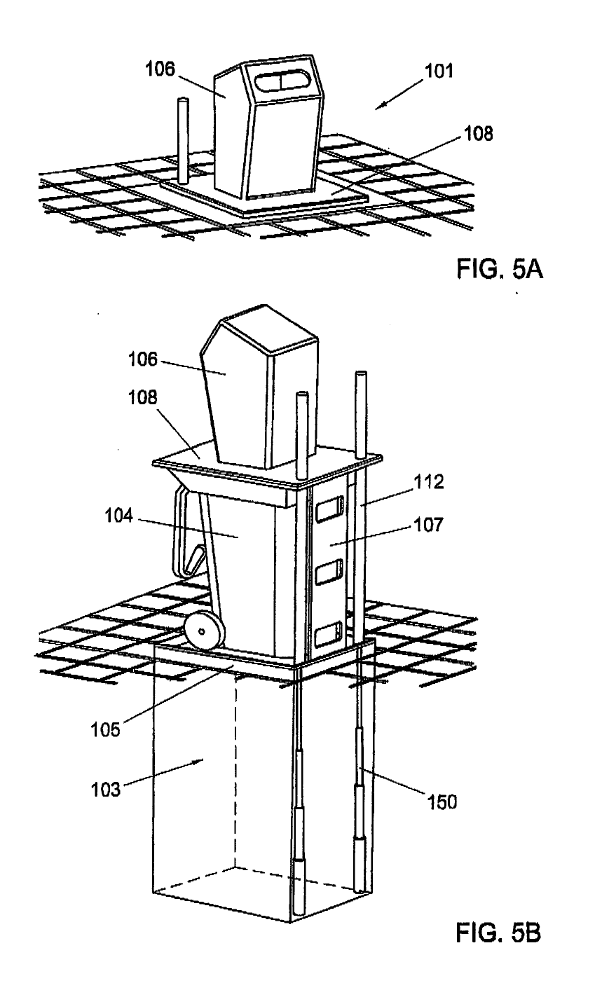

FIGS. 5A, B show a second embodiment of a refuse apparatus according to the invention, in a position of use and in a lifted position suitable for emptying;

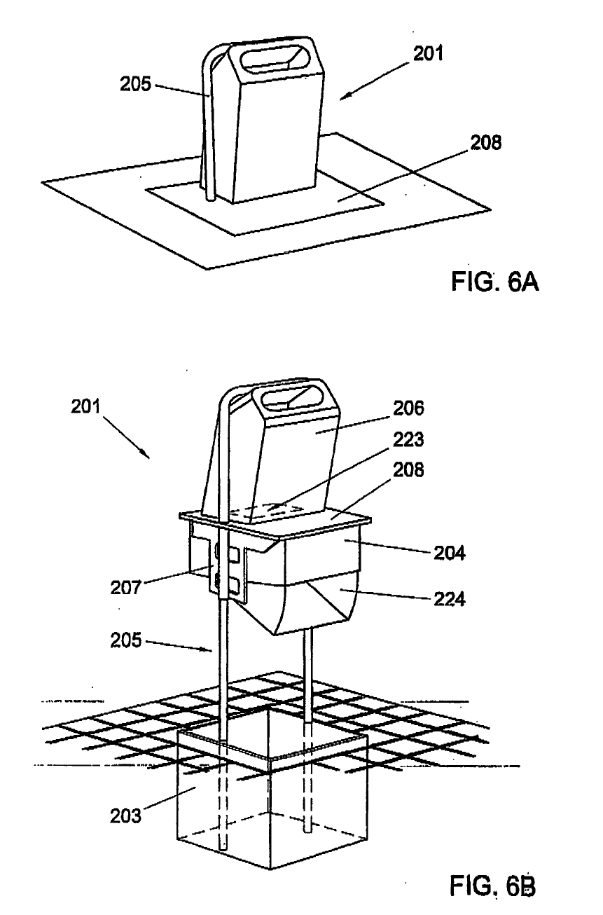

FIGS. 6A, B show a further embodiment of a refuse apparatus according to the invention, in a position of use and a lifted position, and

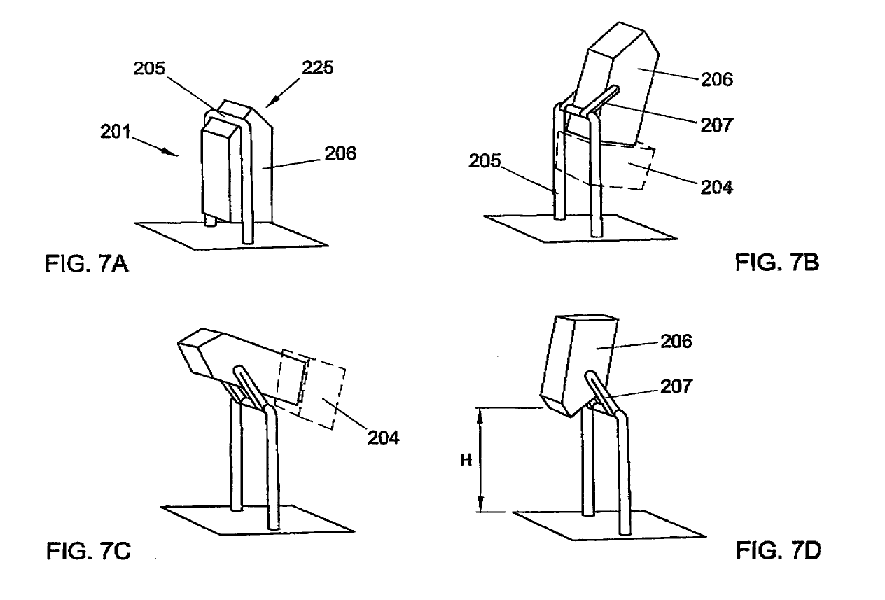

FIGS. 7A-D show a still further embodiment of a refuse apparatus according to the invention in different positions.

The refuse apparatuses to be described hereinafter are intended for receiving refuse in the public space such as (shopping) streets, recreational areas, around public institutions, restaurants, hospital and the like, in addition to or in replacement of known refuse bins. The refuse apparatuses can also be arranged at private persons. ‘Refuse’ is herein understood to mean at least waste produced by consumers, such as, for instance, packaging waste, food leftovers, waste paper, small chemical waste and the like.

The embodiments to be described hereinbelow all comprise a housing situated substantially underground, a storage reservoir which in a first position is situated substantially within the housing, a refuse bin situated above ground in open communication with the storage reservoir, via which refuse can be deposited in the storage reservoir, and lifting means with which the storage reservoir can be moved to a second, above-ground position, in which position the reservoir can be emptied or replaced with an empty reservoir.

In the embodiment shown in FIGS. 1-8, the housing is in the shape of a first tube 3, hereinafter referred to as outer tube 8, which, in a manner to be further described, has been inserted slightly obliquely into the ground as far as an upper edge 2. The centreline M of the outer tube 3 then includes an angle α with the ground level that is less than 90° and is preferably about 70° to 75°, for reasons to be mentioned hereinafter.

The lifting means comprise a second tube 5, hereinafter referred to as lifting tube, received within the first tube 3, which second tube is provided at its outer surface with a toothed rack 11 extending virtually throughout the length of the lifting tube 6. The lifting means further comprise a gear wheel 30, which is arranged adjacent an upper edge 2 of the outer tube 3, in engagement with the toothed rack 11. This gear wheel can be driven via a drive shaft 32 and driving means 35, connectable thereto, and possible transmission means 36, so that the lifting tube 5 can be moved up and down in the outer tube 3 between a first position, corresponding to FIG. 1, in which the lifting tube 5 is received substantially completely within the outer tube 3, and a second position, corresponding to FIG. 2, in which the lifting tube 5, virtually throughout its length, reaches outside the outer tube 3. In order to facilitate movement, guiding strips or guiding projections 38, 39 may be provided on the outer surface of the lifting tube 5 and/or the inner surface of the outer tube 3 (see FIG. 3), manufactured from a material having a low coefficient of friction, for instance nylon. In its simplest embodiment, the lifting tube 5 may be constructed as a framework of a toothed rack and one or more guiding provisions, which are held at a desired relative distance by suitable connecting means. Such an embodiment is also understood to fall within the term ‘lifting tube’, although in that case, of course, there is hardly a ‘tube’ involved.

The storage reservoir is constructed as a third tube 4, hereinafter referred to as storage tube 4, which is pivotably suspended in the lifting tube 6, about a pivot axis 15, adjacent an upper side of the lifting tube 5. This upper side has been halved over a length L which is at least equal to the length L₂ of the storage tube 4, so that the storage tube 4 can pivot freely to a position outside the lifting tube 5, to the position shown in FIG. 2. Adjacent a lower side, the storage tube 4 is pivotably connected with a gas spring 16 which has another end pivotably connected to the lifting tube 5, against the inside thereof, with hinges 17. Further, the lifting tube 6 and storage tube 4 are provided with cooperating locking means 18, with which the storage tube 4 can be locked against pivoting within the lifting tube 5.

The lifting tube 5 may further be provided, adjacent a lower side, with a closing plate 19, as shown in FIG. 2, which is downwardly inclined from the toothed rack side towards the opposite side and is arranged at such a height in the lifting tube 5 that the lowest point of the plate 19 is at some height above the ground level, for instance between 0.2 and 0.5 m, when the lifting tube 5 is in the extended second position shown in FIG. 2. Directly above this lowest point of the plate 19, in the wall of the lifting tube 5, an opening 22 or cock may be provided. Through this provision, moisture, which has for instance leaked from the storage tube 4 into the lifting tube 6, can be drained under the influence of gravity via plate 19 and opening 22 out of the lifting tube 5. Alternatively, the lifting tube 6 may be provided with an open underside, so that moisture present in the lifting tube can be drained via the outer tube 3 to the surrounding ground. Also, in the lifting tube 5, a bucket or like receptacle may be arranged on the plate 19 or be suspended from the tube wall. In the position shown in FIG. 2, this bucket can be taken out of the lifting tube 6 via the open top in order to be emptied.

Adjacent a lower side, the storage tube 4 is provided with a pivotable flap 24, with which the lower side can be selectively closed or cleared. Further, adjacent an upper side, the storage tube 4 is connected with a refuse bin 6, which is in open communication with the tube 4 via an outlet opening 28. This refuse bin 6 is further provided with an inlet opening 25. If desired, the opening 25 may be closed with a flap (not shown). In the exemplary embodiment shown, the refuse bin 6 and the storage tube 4 are constructed as two separate parts, mutually connected by means of flanges 20, 21. However, the refuse bin 6 and storage tube 4 can also be constructed as one integral whole, in which case the term refuse bin 6 is understood to mean the portion that extends above ground in the normal position of use and is provided with an input opening, for throwing in refuse, and the term reservoir 4 is understood to mean that portion that is situated underground in the normal position of use.

Fitted over the edge 2 of the outer tube 3 that projects above ground is a mounting cap 8 which is fixed, for instance screwed or riveted, to the tube edge 2 by way of a tray-shaped ground plate 9. The earlier-mentioned drive shaft 32 with the gear wheel 30 is bearing mounted in the mounting cap 8 by means of bearings 33 fixedly connected with the ground plate 9. Furthermore, within the mounting cap 8, setting means (not shown) may be included, with which the gear wheel 30 can be pressed against toothed rack 11 of the lifting tube 5. In the example shown, the ground plate 9 is covered with a slightly wedge-shaped cover plate 26, provided with an opening 28, to allow the lifting tube 5 and the storage tube 4 to pass. The gap between the opening 28 and the lifting tube 5 that is necessary for clearance can be covered during normal use by the refuse bin 6, in particular a flange 21 thereof, as represented in FIG. 1. Thus, the outer tube 3 and the further parts arranged within the mounting cap 8 sit well protected from external influences. If desired, the refuse bin 6 can be locked to the mounting cap 8 with the aid of locking means (not shown), so that the apparatus cannot be opened and/or emptied by unauthorized persons.

The driving means 85, 36 are preferably constructed as an independent, external unit, which can be coupled to the drive shaft 82 prior to use and uncoupled after use. As a result, not every apparatus 1 needs to be provided with its own driving means 35, 36 and therefore costs can be saved per apparatus 1. The uncoupled driving means 85, 36 can moreover be stored in a safe place after use, protected from damage or abuse by third parties. Naturally, the driving means 35, 36 may also be non-detachably connected with the apparatus 1 and in that case be arranged within the mounting cap 8. The use of driving means 35, 36 not adapted to be uncoupled may be desired, for instance, in the case of distant apparatuses 1, where the costs that might be saved by making use of a drive unit adapted to be uncoupled do not outweigh the inconvenience of having to transport such drive unit over a great distance and coupling and uncoupling same.

The storage tube 4, refuse bin 6 and lifting tube 5 can be manufactured, for instance, from metal, but are preferably manufactured from plastic which may or may not be fibrereinforced. Plastic is easy to process and relatively light, so that the weight of the parts to be lifted up is limited. Plastic is moreover properly cleanable and resistant to moisture and any aggressive substances possibly present in the refuse.

FIG. 4 shows how the apparatus according to FIGS. 1-3 can be installed with a drilling device 40, known per se, which is marketed, for instance, under the name of Vermeer 4000 HL (and of which only a relevant portion is shown schematically in FIG. 4). To that end, the outer tube 3 is transformed into a drill by providing it at an upper side with a coupling piece 43, for coupling to the drilling device 40, and providing it at a lower side with a cutting edge 42, which can be attached as a loose part to the outer tube 3 or can be integrally formed therewith. Next, with the drilling device 40, the outer tube 3 is inserted into the ground, in a manner known per se, with the centreline M of the outer tube 3 preferably including an angle α with the ground level which is between approximately 60° and 80° and is preferably approximately 75°. Next, the ground plate 9 with the drive shaft 82 and gear wheel 30 bearing mounted therein is placed around the upper edge 2 of the outer tube 3 and attached thereto. Next, the lifting tube 6 is placed in the outer tube 8, the gear wheel 30 is set with the aid of the setting means, so that it engages toothed rack 11, and the lifting tube 5 is partly lowered with the aid of the driving means 85. Next, the cover plate 26 is arranged over the lifting tube 5 and secured onto the ground plate 9, and the storage tube 4, with the refuse bin 6 attached thereto, is suspended in the lifting tube 5, about pivot axis 15. After the flap 24 of the storage tube 4 has been closed (manually or with gas spring 16), the storage tube 4 is pivoted against the inner surface of the log tube 5 and locked in this position with the aid of the locking means 18. Lifting tube 6 is then lowered completely, so that the underside of the refuse bin 6 abuts against the cover plate 26 of the mounting cap 8, and flange 21 of the refuse bin 6 closes off the opening 28 in the cover plate 26. If desired, the refuse bin 6 can be locked in this position to the mounting cap 8. After this, the driving means 85, 36 can be uncoupled until further use, and the apparatus 1 is ready for use. The refuse bin 6 here functions as a normal refuse bin, in which passers-by, neighbourhood residents and the like can deposit waste via the inlet opening 25. This waste fills down via opening 23 into the storage tube 4. Optionally, between the refuse bin 6 and the storage tube 4 a check valve can be provided, to stop nasty doors coming from the storage tube 4 and to prevent ingress and egress of vet.

The refuse apparatus 1 can be periodically emptied, but may also be provided with a sensor and suitable communication means, for instance a GSM, SMS, with which the filling degree of the apparatus 1 can, respectively, be measured and passed on to a collection service, so that this service can plan an optimum collection route along the different apparatuses. As a result, manpower and material can be saved and moreover nuisance is limited to a minimum, since under this arrangement the apparatuses are not emptied more often than is necessary, viz. only when they are full.

Emptying of the apparatus 1 is done as follows. After coupling-on the driving means 35, 36, for instance an electric motor or a crank mechanism, the lifting tube 5 including the storage tube 4 and the refuse bin 6 is moved up out of the outer tube 3. The toothed rack or the driving means 35, 36 may here be provided with movement limiters, known per se, not further shown, such as, for instance a microswitch, slip coupling or pressure relief valve, which ensure that the driving means 85, 36 automatically switch off when the liming tube 6 reaches an extreme position. Next, the locking means 18 are unlocked, as a result of which, under the influence of gravity, the storage tube 4 pivots to a vertical position, above a refuse collection facility, such as a refuse collection vehicle, lorry, kliko compost bin, wheeled container, or the like, which has been moved there prior to the unlocking of the locking means 18.

The lengths of the lifting tube 5 and the storage tube 4 and the inclination (angle α) of the outer tube 3 are adjusted to each other, such that the storage tube 4 in pivoted position is at a sufficiently great height H above the ground level and at a sufficient lateral distance X from the apparatus 1, so that a standard refuse collection facility can be arranged under it. It has been found that an angle α of between about 60° and 80° gives a good balance of a sufficient height H on the one hand and a sufficient lateral deflection X on the other, without this requiring the lifting tube 6 and the outer tube 3 to be unduly long.

As the storage tube 4 is pivoted, the gas spring 16 pivot along in outward direction and thus provides for a controlled, damped movement, whereby the storage tube 4 hardly, if at all, exhibits any afterswing. In addition, the gas spring 16 can be connected with the flap 24 in such a manner that this flap is automatically opened at the end of the pivotal movement. As a result, under the influence of gravity, the contents of the storage tube 4 will fall down into the collection facility.

Before bringing the apparatus back into the position shown in FIG. 1, moisture or condensation that has collected on plate 19 or in a bucket (not shown) suspended in the lifting tube 5, can be removed. The empty storage tube 4, which will then be relatively light, is then manually swung, against gravity, back into the lifting tube 5 and locked in that position, whereby the gas spring 16 can automatically close off the flap 24. For that purpose, gas spring 16 may also be attached to the opposite wall with hinges 17. In that case, the gas spring 16, when the storage tube 4 pivots inwards, will be pushed through a dead-centre position and then spring back up slightly, thereby locking the flap 24 and the storage tube 4 in a desired position. In that case, the gas spring 16 can take over the function of the locking means 18. Next, the driving means 35, 36 can be driven in the reverse direction, in order to lower the lifting tube 5 in the outer tube 3, guided by the guiding strips or projections 38, 39 between the lifting tube 5 and the outer tube 3.

Thus, an apparatus 1 according to the invention can be emptied fast, with minimal effort and in a hygienic manner. Moreover, by virtue of its large storage capacity, the apparatus only needs to be emptied infrequently, so that manpower and material can be saved and nuisance can be limited to a minimum. The storage tube 4 can be so dimensioned as to have a volume of, for instance, between 300 and 400 litres. Since this storage capacity is situated substantially underground, the visual impression of the public space is not adversely affected. Moreover, the apparatus 1 can be installed relatively simply, for instance with drilling or pile-driving means known per se. If desired, when emptying the apparatus 1, use can be made of relatively small refuse collection vehicles, which can be driven under the storage tube 4, for instance a wheeled container. This makes the apparatus 1 very suitable for use in cramped and/or difficultly accessible locations. The apparatus 1 can also function as a central refuse bin for one or more households and to that end be arranged in a residential neighbourhood. Naturally, for different types of waste, several apparatuses can be set up, or a single apparatus may be subdivided into several compartments, so that different types of waste can be collected separately. Naturally, the outer tube can also be fitted in the ground in straight orientation, i.e., at right angles to the ground level for instance when there is insufficient space to drill at a slant or to allow the lifting tube to come up out of the outer tube at a slant. In that case, the outward pivotal movement of the storage tube 4 can be supported with the aid of the spring 16.

FIGS. 5A, B show an alternative embodiment of a refuse apparatus 1 according to the invention, in a normal position and an extended position. Parts corresponding to the parts from FIG. 1 are designated by the same reference numeral, increased by 100. The apparatus 101, like the embodiment according to FIGS. 1-3, comprises a housing 103 situated substantially underground, having therein lifting means 105, a storage reservoir 104, a refuse bin 106 situated above-ground and a mounting cap 108.

The housing 103 comprises a substantially rectangular shaft, which may be manufactured, for instance, from concrete, steel or plastic. The lifting means comprise a rectangular bottom plate 105 and, situated above it, a cover plate 108, which is connected with the bottom plate 105 via an upstanding frame part 112. Provided in the cover plate 108 is an opening (not visible) above which a refuse bin 106 is arranged, substantially corresponding to the refuse bin 6 from FIG. 1. Under the opening, a storage reservoir 104 can be set up, on the bottom plate 105, for instance one or more wheeled containers. The bottom plate 105 is movable in the shaft 103 between a first position (shown in FIG. 5A in which the plate 106 is situated adjacent a bottom of the shaft 103, the storage reservoir 104 is substantially received within the shaft 103, and the cover plate 108 closes off the shaft 103, and a second position (as shown in FIG. 5B) in which the bottom plate 105 is situated adjacent an upper side of the shaft 103, substantial flush with the ground level (FIG. 5B). In this second position, the reservoir 104 can be exchanged in an empty reservoir. In order to prevent waste present in the refuse bin 106 from falling down through the opening during exchange, preferably a flap is provided under the opening, which flap automatically closes off the opening when the reservoir 104 is removed. This can be achieved, for instance, with the aid of a bias spring, which is biased in the presence of the reservoir 104 and upon removal of the reservoir 104 is unlocked and then springs back to an untensioned position, thereby closing the flap. By placing a new, empty reservoir 104, the spring is automatically biased again. As a result, the apparatus can simply continue to function during the temporary absence of the reservoir 104 (to be emptied), with the refuse bin 106 serving as temporary storage reservoir. Thus, a single reservoir 104 will suffice.

The bottom plate 106 can be moved, for instance, just like the first embodiment, with a toothed rack and gear wheel combination, whereby the toothed rack may be mounted against the frame part 112 and the gear wheel may be arranged adjacent an upper edge of the shaft 103. The gear wheel can then be driven manually or mechanically. In the exemplary embodiment shown, however, the lifting means comprise a number of spring means 150, in particular two gas compression springs, which are arranged under the bottom plate 105, in line with the two tubular frame parts 112, and are biased such that when the bottom plate 105 is in the first position, they exert an upwardly directed force thereon that is large enough to move this bottom plate 105 and a full container 104 arranged thereon to the second position. Locking means are provided to lock the bottom plate 105 in the fist position against the upwardly acting force of the spring means 150. These long means can for instance be pivoted or slid from an upper edge of the shaft 103 into the path of movement of the bottom plate 105 and mounting cap 8, but are preferably integrated, in the form of a ratchet mechanism, in biasing means, with which the bottom plate 105 can be brought back into the first position. In the case shown in FIG. 513, the biasing means comprise a ladder 107, integrated into the frame part 112, and coupled to a ratchet mechanism (not shown). When a user steps or jumps onto the lower rung, the spring means 160 will be compressed under, respectively, the static or dynamic body weight of the user, after which the user can step up one rung higher. Thus, the bottom plate 105 can be brought down rung by rung, into the shaft 103, while the built-in ratchet mechanism prevents the bottom plate springing back up. Instead of the biasing means and/or the body weight of a user, use can be made of one or more counterweights in order to compensate the weight of the full reservoir 104, so that this can be lifted with a relatively limited force.

The variant embodiment according to FIGS. 5A,B can be dug in with relatively simple, small-scale equipment and thus offers a good alternative at locations where the embodiment shown in FIGS. 1-3 cannot be placed, for instance because there is insufficient space for the drilling device 40 and/or insufficient drilling depth owing to barriers present in the ground, such as foundations or roots of trees. A further advantage of the embodiment shown in FIGS. 5A,B is that in it a standard container 104 can be used, which can be replaced in its entirety by an empty container. Also, the apparatus ran be so dimensioned that it can accommodate several containers 104 next to each other (combined with several refuse bins 106), which can all be lifted with the same lifting means 105. Such an apparatus with several containers is suitable, for instance, for separate reception of waste or for use by several households. Yet a further advantage of the embodiment according to FIGS. 5A,B is that for driving the lifting means, no expensive driving means are needed. Thus, this embodiment is very suitable for household-by-household use. This is not to say that the other embodiments shown in this description are not suitable for household-by-household use.

FIGS. 6A, B show a farther variant embodiment in a normal position of use (FIG. 6A) and in a lifted position (FIG. 6B), in which latter position the apparatus can be emptied. Insofar as the apparatus is built up from the same parts as the earlier embodiments, these parts are designated with the same reference numeral, increased by 200.

In this embodiment, the housing 208 is constructed as a relatively shallow trough, which is closable with a cover plate 208. The trough 203 has a rectangular shape in the case shown, but can naturally also have a different shape, for instance a cylinder shape. Mounted under the cover plate 208 is a storage reservoir 204, while on top of the cover plate 208 a same refuse bin 206 is provided as in the two preceding embodiments. This refuse bin 206 is in communication with the storage reservoir 204 via an opening 228 in the cover plate 208. In a normal position of use, the storage reservoir 204 is received in the housing 203 with a proper fit, the housing 208 being closed off by the cover plate 208, which is substantially flush with the ground level. In this embodiment, the lifting means 205 are formed by a U-shaped frame from which are suspended the refuse bin 206, cover plate 208 and the reservoir 204. The legs of the U have been inserted into the ground on opposite sides of the housing 203, in guide tubes provided in the ground for that purpose.

For the purpose of emptying the apparatus 201, it can be pulled up manually by the U-shaped bracket, as shown in FIG. 6B, and be secured in that position with blocking means provided for that purpose, after which the storage reservoir 204 can be emptied, via a swinging flap provided for that purpose at an underside of the storage reservoir 204. Thereafter, the blocking can be removed and the apparatus can be lowered manually until the cover plate 208 closes off the housing 203 again In this position, the cover plate 208 is preferably locked to the housing 203, so that the refuse apparatus 201 cannot be emptied by unauthorized persons. Alternatively, instead of or in addition to being provided with a manual operation, the apparatus 201 can be provided with mechanical lifting means, similar to the lifting means according to FIGS. 5A, B. These can be biased, in the same manner as discussed with reference to FIG. 5B, with a ladder 207 attached to the apparats 201. Furthermore, one or more counterweights may be provided, in order to compensate the weight of the full reservoir at least partly during lifting.

This embodiment, like the preceding embodiment, offers the advantage that the storage capacity of a refuse bin known per se can be enlarged, preferably at least doubled, in a very simple manner, without far-reaching measures, without adversely affecting the visual impression of the street. As a result, the apparatuses need to be emptied less often, which is a major advantage specifically for refuse bins situated at locations that are difficult to access. By virtue of the relatively small dimensions, the required underground space can be dug out simply and, if necessary, without machines, so that this embodiment, too, lends itself particularly well for small-scale household use (in contrast to larger-scale industrial or communal use).

FIGS. 7A-D represent a further variant of the embodiment shown in FIG. 6, in which the refuse bin 206 is pivotably suspended from the U-shaped frame 205 with the aid of two arms 207 hinge-mounted on opposite sides of the refuse bin 206. The refuse bin 206 can be provided, adjacent an underside thereof, with a same reservoir 204 as in FIG. 6, to ere the storage capacity (represented in broken lines). This reservoir 204, however, does not need to be provided with a swinging outlet flap, for reasons that will become clear hereinbelow.

The apparatus according to FIG. 7 can be emptied by pulling up the U-shaped frame 205, as in the embodiment shown in FIG. 6, in order to lift the underground reservoir 204 above ground. After this, the refuse bin 206 and the subjacent reservoir 204 are pivoted up by way of said arms 207 (see FIG. 7B) to a point beyond the highest point of the U-frame 205, if desired, a stop (not shown) may be provided, which ensures that the arms cannot be pivoted further than the position shown in FIG. 7C. Then, the refuse bin 206 is tilted upside down, as shown in FIGS. 7C and 7D, so that the contents stored therein will fall under the influence of gravity out of the inlet opening into a subjacent receptacle bag or container.

This embodiment offers the advantage that the discharge opening (inlet opening 225), through an appropriate design of the pivoting arms 207, can be easily brought to a relatively great height H above the ground, so that a container or trailer with a loading platform can be arranged under it. Moreover, in this embodiment, the reservoir 204 can be made of very simple design, without outlet opening and closable flap. Alternatively, the reservoir 204, or, in the absence thereon the refuse bin 206, may be provided with an outlet gap, so that the apparatus 201 can be emptied in the position shown in FIG. 7C.

Because of the small dimensions of the storage reservoir, the apparatus can be simply operated manually. Of course, also mechanical aids may be provided. Thus, the lower parts of the U-shaped frame 205 may be designed, for instance, as screw spindles, which can be driven via mechanical driving means, and the tilting of the refuse bin 206 can be realized, for instance, by means of hydraulically or pneumatically driven piston-cylinder assemblies. These driving means too are preferably adapted to be uncoupled, for the same reasons as explained hereinbefore with reference to FIGS. 1-4.

It is noted that the embodiments with lifting means to be operated manually, in particular as shown in FIGS. 57, can also be advantageously designed without the limiting measures of the main claim. Thus, the reservoir of such embodiments may not be situated underground, or only partly so, in a first position and be lifted from this first position to a second position, to a point so far above the road surface that a collection vehicle or the like can be moved under the reservoir, into which the reservoir can be discharged. The lifting means to be operated manually offer advantages specifically (though not exclusively so) in relatively small-scale embodiments in which the reservoirs are so dimensioned that the weight thereof in filled condition is substantially equal to the average weight of an adult person.

The invention is not limited in any way to the exemplary embodiments shown in the description and the drawing. All combinations of parts of exemplar embodiments shown and described in this description are also understood to fill within the concept of the invention. Moreover, many variations thereon are possible within the framework of the invention outlined by the claims.

Thus, the refuse bin and a reservoir connected thereto of all embodiments shown can be provided with several, separate compartments for separate reception of different types of waste, such as glass, waste paper, degradable waste. Also, other lifting means and driving means may be employed. The lifting means can, for instance, comprise a jack, lever, counterweight or pump mechanism, mechanical or pneumatic spring means, or means drivable by a gear wheel, pulley or sheave, such as a toothed rack cable, chain or screw spindle.

These and many variations are understood to fall within the framework of the invention as set forth in the following claims.

1. An apparatus for collecting refuse, comprising
a refuse bin with an inlet opening and an outlet opening;
a housing preferably situated at least largely underground;
a reservoir which in a first position is received substantially within the housing and is in open communication with the outlet opening of the refuse bin; and
lifting means which are received at least partly in the housing and are arranged for moving the reservoir between said first position and a second position, in which the reservoir is situated above ground, such that it can be emptied or replaced with an empty reservoir.

2. An apparatus according to claim 1, wherein the reservoir is pivotably connected with the lifting means, so that the reservoir can be brought into the second position by pivoting.

3. An apparatus according to claim 2, wherein the apparatus is arranged for pivoting the reservoir under the influence of gravity.

4. An apparatus according to claim 1, wherein the lifting means are drivable manually, by manpower.

5. An apparatus according to claim 1, wherein the lifting means comprise compensation means for compensating the weight of the reservoir, at least in filled condition, and at least during the displacement of the reservoir from the first to the second position.

6. An apparatus according to claim 5, wherein the compensation means comprise at least one counterweight.

7. An apparatus according to claim 4 or 5, wherein the lifting means comprise spring means and biasing means for biasing the spring means with a biasing force which is sufficiently great to move a full reservoir from the first to the second position, and wherein the apparatus further comprises locking means for securing the spring means in the biased position, the biasing means being so arranged that they can be operated by the body weight of an adult.

8. An apparatus according to claim 7, wherein the spring means comprise a pneumatic spring, and wherein the biasing means and the locking means comprise a ratchet mechanism.

9. An apparatus according to claim 1, wherein the lifting means are at least partly mechanically drivable, while the driving means are preferably adapted to be coupled-on as an external unit.

10. An apparatus according to claim 1, wherein the refuse bin moves along with the reservoir between the first and second position.

11. An apparatus according to claim 1, wherein the refuse bin is movable separately from the reservoir, the arrangement being such that the refuse bin, prior to the movement of the reservoir, can be brought out of the path of movement thereof.

12. An apparatus according to claim 1, wherein the housing comprises a first tube and the reservoir comprises a second, shorter tube, which is received in the first tube so as to be movable by means of lifting means.

13. An apparatus according to claim 12, wherein the lifting means comprise a toothed rack, which is mounted on the second tube, against a side thereof facing the first tube, and which extends in axial direction over a length greater than that of the second tube, and wherein the lifting means furthermore comprise a drivable gear wheel, which is arranged adjacent an upper end of the first tube, in engagement with the toothed rack.

14. An apparatus according to claim 13, wherein the second tube adjacent an upper end thereof is pivotably connected with the toothed rack, about a pivot axis extending substantially horizontally.

15. An apparatus according to any one of claims 12-14, wherein the first tube is placed at an angle in the ground, the centreline of the tube including an angle with the ground surface which is between approximately 60° and 90° and is preferably approximately 75°.

16. An apparatus according to claim 12, wherein the tubes and lifting means are so dimensioned that with these the second tube can be moved to outside the first tube to a second position, in which an outlet opening of the second tube is situated between approximately 1 and 2 m and preferably approximately 1.5 m above ground, the arrangement being such that under this outlet opening a collection facility such as a dustcart can be arranged.

17. An apparatus according to claim 1, wherein the housing is so dimensioned that in it a standard household refuse container is receivable and the lifting means comprise a platform movable up and down in the housing, on which the container is displaceable between the first and second position.

18. An apparatus according to claim 1, wherein an outlet opening of the reservoir is provided with a flap and closing means, the closing means being arranged to open the flap when the reservoir is in the second position and to close the flap when the reservoir moves towards the first position.

19. An apparatus according to claim 1, wherein in the refuse bin or the reservoir measuring means are arranged, which are connected to communication means, for measuring and passing on to a user a filling degree of the apparatus.

20. An apparatus according to claim 1, wherein the refuse bin and the reservoir comprise several compartments for separate reception of different types of waste.

21. An apparatus according to claim 1, wherein the inlet opening is also the outlet opening.

22. A method for installing an apparatus according to claim 12, wherein the first tube, at a first end thereof, is fitted with a drilling bit and at an opposite second end in coupled to a drilling device, after which the first tube is introduced into the ground with the drilling device, after which the second tube is placed within the first tube with the aid of the lifting means, and is moved to a first position.
